(19) United States
(12) Patent Application Publication
(10) Pub. No.: US 2003/0009118 A1
(43) Pub. Date: Jan. 9, 2003

(54) Massage ball attached to a handle strap

(76) Inventors: Raymond John Sabo, Watsonville, CA (US); Kathleen Rose Sabo, Watsonville, CA (US); Tiffany Joy Sabo, Watsonville, CA (US); Sean Phillip Sabo, Watsonville, CA (US); Koreana Hope Sabo, Watsonville, CA (US); Justin Vitaly Sabo, Watsonville, CA (US)

Correspondence Address: Raymond Sabo, 1184 Green Valley Road, Watsonville, CA, 95076, US

(21) Appl. No.: 09/893,061

(22) Filed: Jun. 28, 2001

(51) Int. Cl. A61H 7/00

(52) U.S. Cl. 601/137

(57) ABSTRACT

A hand held massaging devise that allows people to personally massage themselves in hard to reach areas of the back specifically from the neck, around the spine, and all the way down the back including the buttocks. A flexible elastic strap is folded in half, and permanently attached to a piece of durable nylon material that attaches to a solid rubber ball with multiple protrusions radiating outward. The connection between the material and the rubber ball is attached in such a way as to allow the ball to rotate freely in circular, side to side, or up and down motion. The user comfortably holds the elastic strap while leaning back against a wall or flat surface positioning the ball on the part of the back being massaged, applying the desired pressure. The user may also freely massage his or her foot by holding the elastic strap, positioning the ball between the foot and the floor, and moving the foot back and forth while applying pressure. Therefore, this device can conveniently and comfortably allow people to massage themselves anywhere whether traveling, at home, or in the office.

### CROSS REFERENCE TO RELATED APPLICATIONS

| | | | |
|---|---|---|---|
| 4266536 | May 12, 1981 | Casares | 601/119 |
| 5779652 | Jul. 14, 1998 | Mencher-Aliazzo | 601/132 |
| 6241696 | Jun. 5, 2001 | York | 601/137 |
| 5787541 | Aug. 4, 1998 | Chen | 15/222 |
| 6146343 | Nov. 14, 2000 | Stewart | 601/118 |
| 4116233 | Sep. 26, 1978 | Scaduto | 601/46 |
| 3972322 | Aug. 3, 1976 | Finn | 601/122 |
| 5868689 | Feb. 9, 1999 | Faroky-Allen | 601/120 |

### STATEMENT REGARDING FEDERALLY SPONSORED RESEARCH OR DEVELOPMENT

“Not Applicable”

### REFERENCE TO A MICROFICHE APPENDIX “Not Applicable”

1. Field of the Invention

The present invention relates to massaging devices and more specifically to a hand held ball type massaging device.

2. Background of the Invention

This invention relates generally to self-applied massaging devices to help relax and work out tightened muscles. From our own experience and research, we found that tightened muscles in your back can block the energy flow of the nerves that are connected to your spine which affect many areas of your body from head to toe. When nerves are pressured by tight muscles they can cause pain and discomfort to organs and different parts of the body. Most devices on the market today require more than one person to reach the areas of the back effectively or require the extension of an arm whereby putting stress on the arm muscles and in some cases, a person can not effectively massage himself comfortably. Other devices are difficult to transport in a suitcase or bulky to store in a place away from home such as an office.

Therefore, there is always a need to have a massage device that can be comfortably and effectively applied unassisted and can be easily and simply used even while traveling or at work where tensions seem to affect people daily.

### BRIEF SUMMARY OF THE PRESENT INVENTION

It is the object of the present invention to provide a convenient and effective way for people to massage their muscles anytime and anywhere a wall or flat surface can be utilized as well as comfortably massaging the hard to reach areas of the back or the bottom of feet.

Along both sides of the spine and throughout the body are pressure points. These pressure points affect many areas of the body. As pressure is applied on these points by leaning on the specially formulated massage ball and moving side to side, up and down or in a circular motion, energy can be released to different areas of the body and tight muscles have the potential to be relaxed.

### BRIEF DESCRIPTION OF THE DRAWINGS

The way for the present invention to be best understood is by referring to the following detailed description of the present invention and the accompanying drawings, wherein

FIG. 1 shows the Full View of the massage ball with a handle strap.

FIG. 2 shows the Bottom View with protrusions on the massage ball.

FIG. 3 shows the Side View of the massage ball

FIG. 4 shows the Inside View of the Molded Out Area, which is on top of the massage ball.

FIG. 5 shows the Top View of the massage ball containing the Molded Out area.

FIG. 6 shows an Open Side View showing how the Screw and Washers connect the material to the ball.

FIG. 7 shows the Material that is connected to both the ball and elastic strap. It also shows the hole where the screw goes through to attach the Material to the ball.

FIG. 8 shows the View of the Braided Elastic Strap.

FIG. 9 Illustrates the Use of the massage ball by leaning against a wall or any flat surface.

FIG. 10 Illustrates the Use of the massage ball by placing the massage ball under a foot.

### DETAILED DESCRIPTION OF THE INVENTION

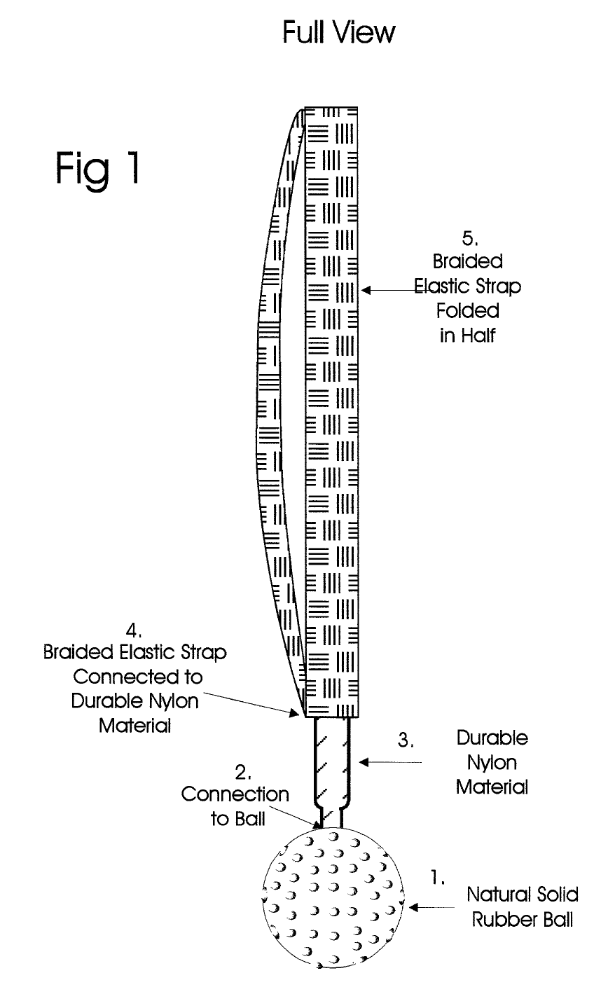

As best shown in FIG. 1, the present invention involves a Natural Solid Rubber Ball 1, a Connection to the Ball 2, a Durable Nylon Material 3, a Braided Elastic Strap Connected to Durable Material 4, and a Braided Elastic Strap 5 Folded in Half.

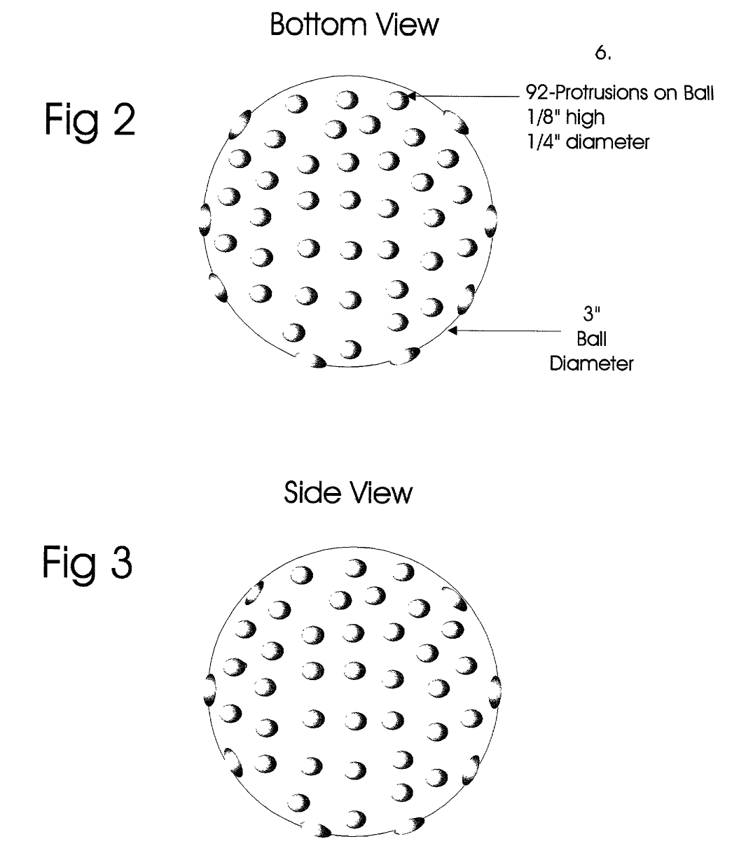

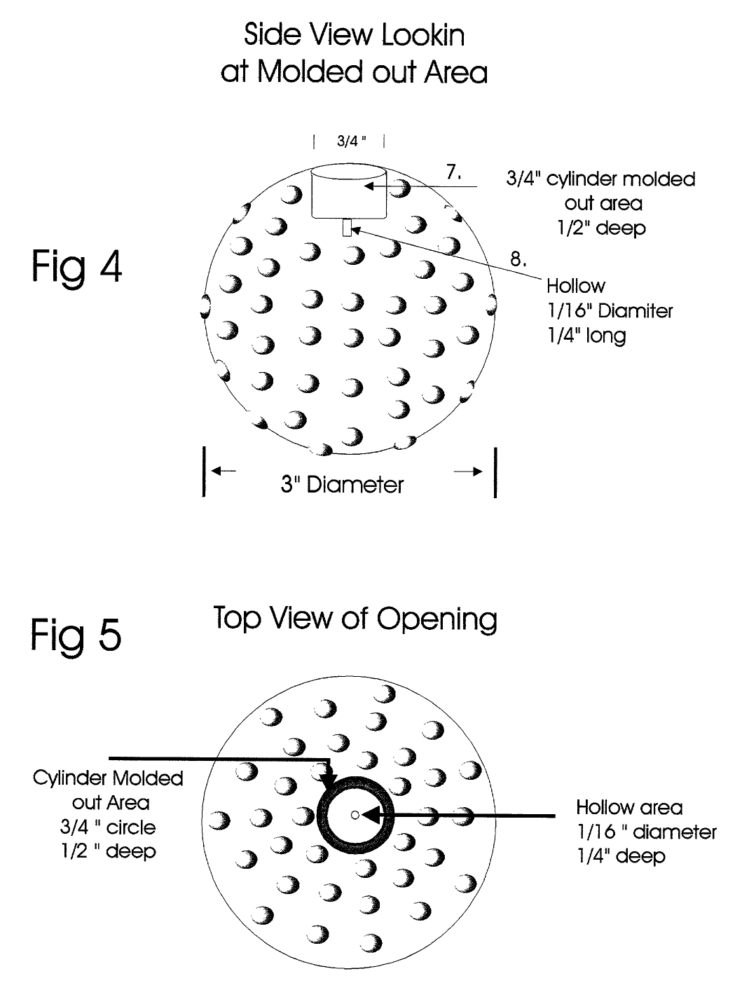

As shown in FIG. 2 and FIG. 3, this massage ball 1 has a 3″ diameter with 92 protrusions 6 radiating outward around the ball 1 with the exception of the molded out area 7 as illustrated in FIG. 4 and FIG. 5. Each of the 92 protrusions 6 measured ⅛″ high with a ¼″ diameter. The ball 1 with the protrusions 6 has a circumference of approximately 10″. These protrusions 6 aid in the continuous stimulation of different pressure points by the degree of pressure applied during the massage.

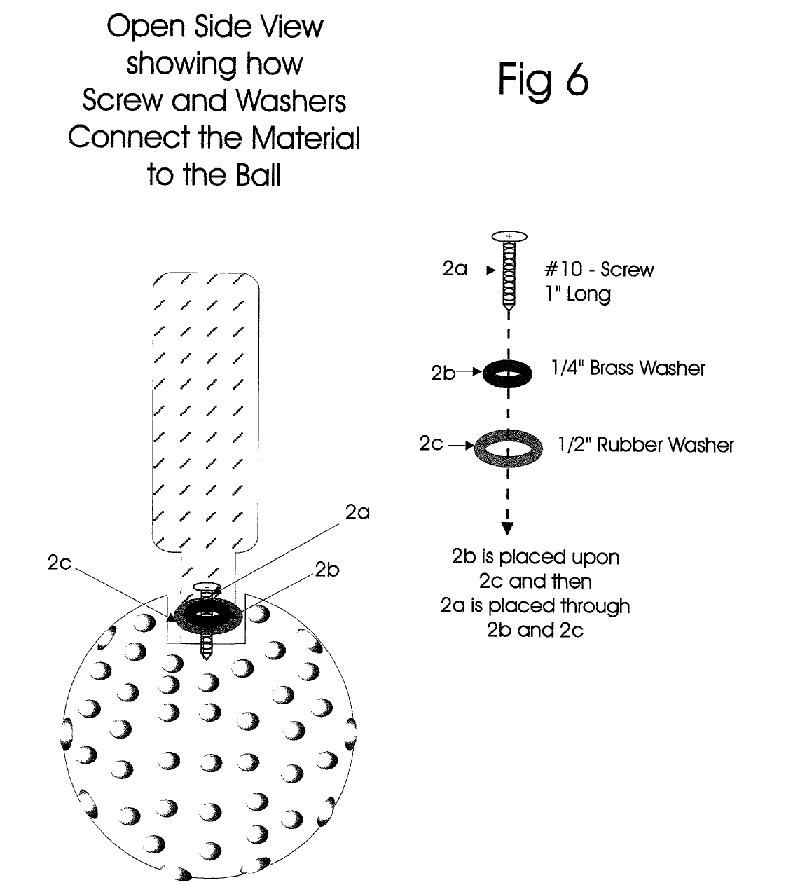

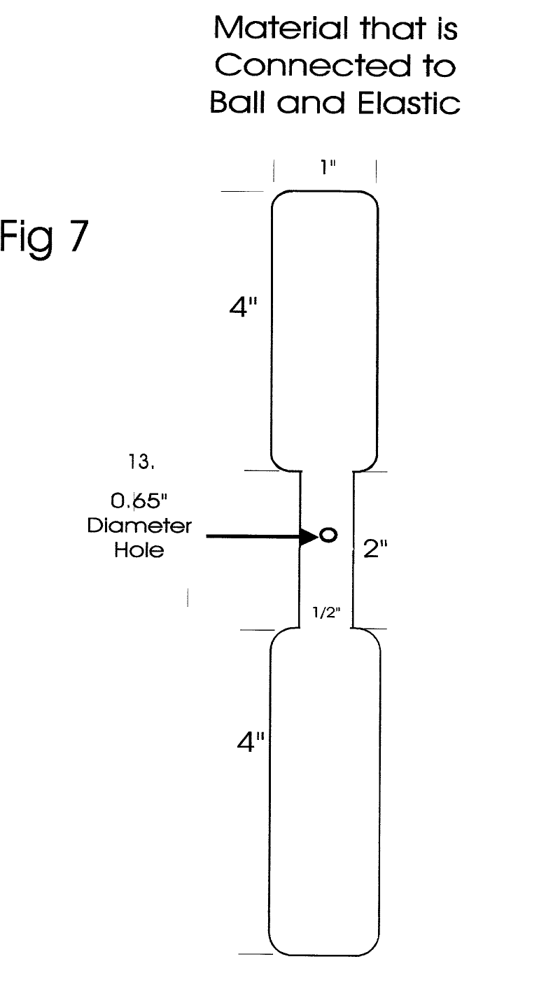

FIG. 4 and FIG. 5 illustrate the cylinder molded out area 7. This area is uniquely constructed in order to connect the material 3 shown in FIG. 7 with the ball 1 using a screw 2a and washers 2b, 2c as shown in FIG. 6 in a way to allow for flexibility and freedom of motion while the user 10 massages. This molded out cylinder shape 7 shown in FIG. 4 is ¾″ in diameter and ½″ deep with an extended hollowed out 1/16″ by ¼″ section 8 from the bottom center as shown in FIG. 4 and FIG. 5.

Referring now to FIG. 6, the open side view shows how the screw 2a and washers 2b, 2c connect the material 3 to the ball 1. A #10 1″ long screw 2a is placed through ¼″ brass washer 2b which was placed upon the ½″ rubber washer 2c and then pushed through the center hole 13 of the material 3 as shown in FIG. 7. This screw 2a and washer 2b, 2c combination is then partially screwed into the hollowed area 8 in the center of the molded out cylinder shape 7 of the ball 1 as shown in FIG. 6. The screw 2a is not inserted all the way down but is approximately only halfway inserted so that the material 3 does not twist while the user 10 applies pressure to the ball 1 moving in a right and left direction or side to side motion.

The material 3 is shown in FIG. 7 as it appears before it is attached to the Ball 1. The material 3 is made from durable nylon and contains a 0.65″ diameter hole 13 in the center. The shape and the dimensions of this material 3 are recorded in FIG. 7. This material 3 is folded in half and the two ends are securely sewn together 4 with and between the two ends of the elastic strap 5 as illustrated in FIG. 1

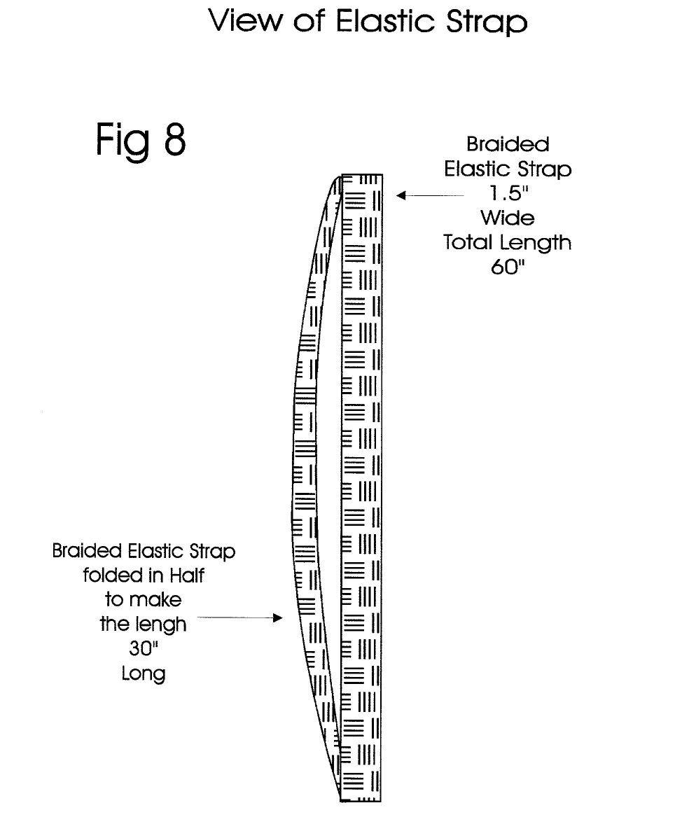

As shown in FIG. 8, the Elastic Strap 5 is 1.5″ by 60″ folded in half and securely sewn to the durable nylon material 3 as shown in FIG. 1 making it 30″ long. The benefits of the elastic 5 are:

a) The elastic strap 5 allows flexibility to the massage ball 1 when the user 10 places it on different locations of the body.

b) The elastic strap 5 allows the user 10 to rotate the massage ball 1 in a circular motion or move it in an up and down motion.

c) The elastic strap 5 also tremendously reducing the tension placed on the material 3 that is connected to the elastic strap 5 as shown in FIG. 1

d) The elastic strap 5 also tremendously reduces the strain on the center of the material 3 and the screw 2a and washers 2b, 2c connected to the ball 1 as shown in FIG. 6.

The benefits of the elastic strap 5 being sewn in half are:

a) The user 10 may choose to comfortably hold the strap 5 inside the fold.

b) Or the user 10 may choose to hold the outside of the strap 5 and therefore having double cushion on the palm of the hand.

c) The massage ball 1 can be conveniently hung for storage.

Mode of Operation

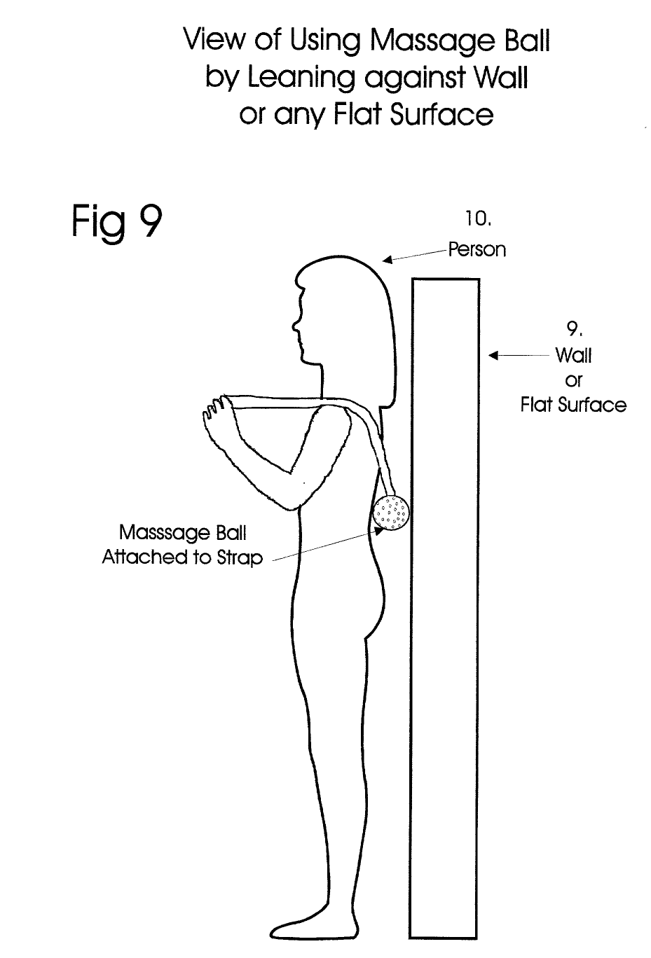

As illustrated in FIG. 9, the user 10 comfortably holds the elastic strap 5 while leaning back against a wall 9 or flat surface 9 positioning the ball 1 on the part of the back being massaged, applying the desired pressure. The present invention allows the ball 1 to rotate freely in circular, side to side, or up and down motion.

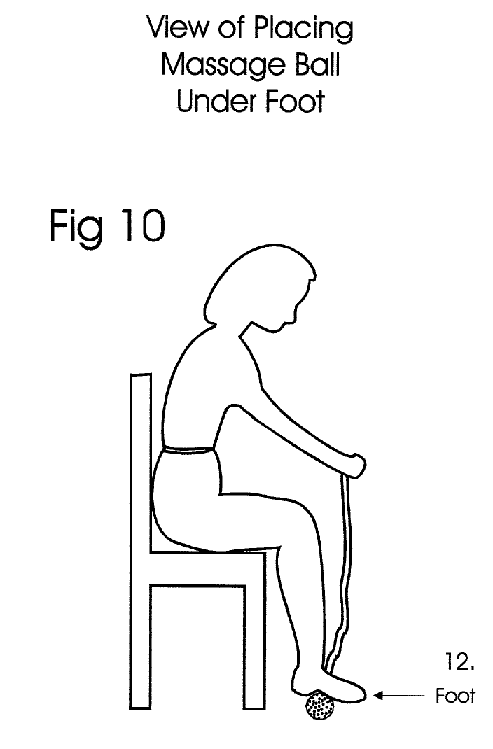

Now, referring to FIG. 10, the user 10 may also freely massage his or her foot 12 by comfortably holding the elastic strap 5, positioning the ball 1 between the foot 12 and the floor, and moving the foot 12 back and forth while applying pressure.

It should be understood that the drawings, mode of operation, and description of the present invention are illustrative and explanatory, and that various changes and modifications in structure and procedure may be made in the invention without departing from the spirit and scope thereof.

We claim:

1. Massage ball attached to a strap, comprising
(a) a flexible braided elastic strap folded in half and permanently attached to the said piece of durable nylon material that attaches to the said natural sold rubber ball, and;
(b) a uniquely shaped folded piece of durable nylon material, connecting, through the hollow center section of the said cylinder shaped molded out area, said material with the said ball using the said screw, brass washer and rubber washer, and;
(c) a natural solid rubber ball with protrusions radiating outward around the said ball except for the area containing a cylinder shaped molded out area with a hollow section in the center to insert the said screw with said washers.
